(19) United States
(12) Patent Application Publication
(10) Pub. No.: US 2010/0278499 A1
(43) Pub. Date: Nov. 4, 2010

(54) Fiber Optic Panels Configured to Retain Fiber Optic Components in a Depth Space of a Chassis

(76) Inventors: Marcel G. Mures, Fort Worth, TX (US); Manuel Alejandro Lopez Sanchez, Reynosa (MX); Antwan J. Works, Lewisville, TX (US)

Correspondence Address: CORNING INCORPORATED, INTELLECTUAL PROPERTY DEPARTMENT, SP-TI-3-1, CORNING, NY, 14831, US

(21) Appl. No.: 12/433,403

(22) Filed: Apr. 30, 2009

(51) Int. Cl. G02B 6/00

(52) U.S. Cl. 385/135

(57) ABSTRACT

Embodiments disclosed in the detailed description include fiber optic panels and related apparatuses configured to retain fiber optic components for establishing fiber optic connections. The fiber optic panels are configured such that the fiber optic components and any fiber optic connections made to the fiber optic components can be retained along a depth axis in a depth space of a chassis when the fiber optic panel is inserted into the chassis. The longitudinal axes of the fiber optic components are not parallel to the depth axis of the chassis. In this manner, the area of the depth space of the chassis is utilized to retain fiber optic components so that a greater density of fiber optic components can be supported by fiber optic panels for a given length of the chassis. The fiber optic panel may be any type of fiber optic patch panel or fiber optic module.

### BACKGROUND

1. Field of the Disclosure

The technology of the disclosure relates to fiber optic panels having fiber optic components for establishing fiber optic connections.

2. Technical Background

Benefits of optical fiber use include extremely wide bandwidth and low noise operation. Because of these advantages, optical fiber is increasingly being used for a variety of applications, including but not limited to broadband voice, video, and data transmission. Fiber optic networks employing optical fibers are being developed and used to deliver voice, video, and data transmissions to subscribers over both private and public networks. These fiber optic networks often include separated connection points at which it is necessary to link optical fibers in order to provide “live fiber” from one connection point to another connection point. In this regard, fiber optic equipment is located in data distribution centers or central offices to support interconnections.

The fiber optic equipment is customized based on the application need, and is typically included in housings that are mounted in equipment racks to maximize space. One example of such fiber optic equipment is a fiber optic panel. A fiber optic panel is designed to provide cable-to-cable fiber optic connections. The fiber optic panel is typically mounted to a chassis mounted inside an equipment rack or housing. Fiber optic adapters are disposed through openings on a front of the panel and accessible to receive fiber optic connectors from connectorized fiber optic cables to establish fiber optic connections. Due to increasing bandwidth needs and the need to provide higher connectivity density in data centers, it may be desired to provide panels having a high adapter count. However, one factor that influences the number of adapters included is the amount of surface area on the front of the panel. Further, another factor is the number of adapters included in a fiber optic panel providing sufficient finger access to connect connectors to the adapters. In this regard, the openings in the fiber optic panel are spaced to provide sufficient finger access between adapters thus limiting the density of adapters that can be included in the panel. The density of adapters and panels is also influenced by the fiber's minimum bend radius.

### SUMMARY OF THE DETAILED DESCRIPTION

Embodiments disclosed in the detailed description include fiber optic panels and related apparatuses configured to retain fiber optic components for establishing fiber optic connections. The fiber optic panels are configured such that the fiber optic components and any fiber optic connections made to the fiber optic components can be retained along a depth axis in a depth space of a chassis when the fiber optic panel is inserted into the chassis. The fiber optic components are oriented in the fiber optic panel such that the longitudinal axes of the fiber optic components are not parallel to the depth axis of the chassis. In this manner, the area of the depth space of the chassis is utilized to retain fiber optic components so that a greater density of fiber optic components can be supported by fiber optic panels for a given length of the chassis. The fiber optic panel may be any type of fiber optic patch panel or fiber optic module. The fiber optic components retained by the fiber optic panels may be any type of fiber optic component, including but not limited to fiber optic adapters and connectors.

In one embodiment, a chassis is provided having a first end and a second end aligned along a depth axis of the chassis and having a depth space therebetween. The depth axis is provided along a Z-axis of the chassis. A fiber optic panel in the form of a fiber optic patch panel is provided. The fiber optic patch panel is configured to be inserted into the chassis between the first end and the second end along the depth axis of the chassis. The fiber optic patch panel is configured to retain a plurality of fiber optic components in the depth space between the first end and the second of the chassis. The plurality of fiber optic components are oriented in the fiber optic patch panel such that the longitudinal axes of the fiber optic components are not parallel to the depth axis. When it is desired to access the fiber optic components retained by the fiber optic patch panel, the fiber optic patch panel can be moved out or extended from the chassis to gain access to the fiber optic components. The fiber optic patch panel can be moved back or retracted into the chassis for storage when access is completed such that the fiber optic components and fiber optic connections made to the fiber optic components are retained in the depth space of the chassis.

Embodiments disclosed herein also include a fiber optic panel used to support and retain fiber optic components in a depth space of a chassis comprised of a planar member. The planar member is disposed in a plane between a first end and a second end of the planar member such that fiber optic components retained in the fiber optic panel are retained in a depth axis in a depth space of a chassis when the fiber optic panel is installed in the chassis. The plurality of fiber optic components are retained in a plurality of openings disposed in a planar surface of the planar member. The plurality of openings may be oriented orthogonally or substantially orthogonally to the plane of the planar member.

Embodiments disclosed herein also include a fiber optic panel chassis comprising an enclosure and having an opening disposed therein along a depth axis of the chassis between a first end and a second end of the chassis. At least one first channel is disposed in an inner surface of a first side of the enclosure along the depth axis of the chassis. At least one second channel is disposed in an inner surface of a second side of the enclosure along the depth axis opposite the first side such that the channels are aligned. The enclosure of the chassis is configured to receive a fiber optic panel in the depth axis inserted in the at least one first channel and the at least one second channel of the enclosure. Additional channels can be arranged on inner surfaces of the enclosure adjacent to the inner surfaces of the first and second sides of the enclosure.

Additional features and advantages of the embodiments will be set forth in the detailed description which follows, and in part will be readily apparent to those skilled in the art from that description or recognized by practicing the embodiments as described herein, including the detailed description that follows, the claims, as well as the appended drawings.

It is to be understood that both the foregoing general description and the following detailed description present embodiments, and are intended to provide an overview or framework for understanding the nature and character of the embodiments. The accompanying drawings are included to provide a further understanding of the embodiments, and are incorporated into and constitute a part of this specification. The drawings illustrate various embodiments, and together with the description serve to explain the principles and operation of the embodiments.

### BRIEF DESCRIPTION OF THE FIGURES

FIG. 1 is an exemplary fiber optic equipment rack including a chassis housing an exemplary fiber optic panel employing exemplary moveable fiber optic component frames having fiber optic components retainable in a depth dimension;

FIG. 2 is a front perspective view of an exemplary fiber optic panel employing exemplary moveable, vertically oriented fiber optic cable routing and adjacent fiber optic component panels having fiber optic components retainable in a depth space of a chassis;

FIG. 3A is a front perspective view of a fiber optic component panel employed in the fiber optic panel of FIG. 2;

FIG. 3B is a front perspective schematic view of a guide panel employed in the fiber optic panel of FIG. 2;

FIG. 4A is a front perspective view of an exemplary chassis that is configured to support fiber optic component panels retainable in a depth space of the chassis in either a horizontal or vertical orientation;

FIG. 4B is a front view of the chassis of FIG. 4A;

FIG. 5 is the fiber optic cable routing and fiber optic component panels of FIG. 2 installed in a vertical orientation in the chassis of FIGS. 4A and 4B; and

FIG. 6 is the fiber optic cable routing and fiber optic component panels of FIG. 2 installed in a horizontal orientation in the chassis of FIGS. 4A and 4B.

### DETAILED DESCRIPTION OF THE EMBODIMENTS

Reference will now be made in detail to the embodiments, examples of which are illustrated in the accompanying drawings, in which some, but not all embodiments are shown. Indeed, the embodiments may be embodied in many different forms and should not be construed as limiting herein; rather, these embodiments are provided so that this disclosure will satisfy applicable legal requirements. Whenever possible, like reference numbers will be used to refer to like components or parts.

Embodiments disclosed in the detailed description include fiber optic panels and related apparatuses configured to retain fiber optic components for establishing fiber optic connections. The fiber optic panels are configured such that the fiber optic components and any fiber optic connections made to the fiber optic components can be retained along a depth axis in a depth space of a chassis when the fiber optic panel is inserted into the chassis. The fiber optic components are oriented in the fiber optic panel such that the longitudinal axes of the fiber optic components are not parallel to the depth axis of the chassis. In this manner, the area of the depth space of the chassis is utilized to retain fiber optic components so that a greater density of fiber optic components can be supported by fiber optic panels for a given length of the chassis. The fiber optic panel may be any type of fiber optic patch panel or fiber optic module. The fiber optic components retained by the fiber optic panels may be any type of fiber optic component, including but not limited to fiber optic adapters and connectors.

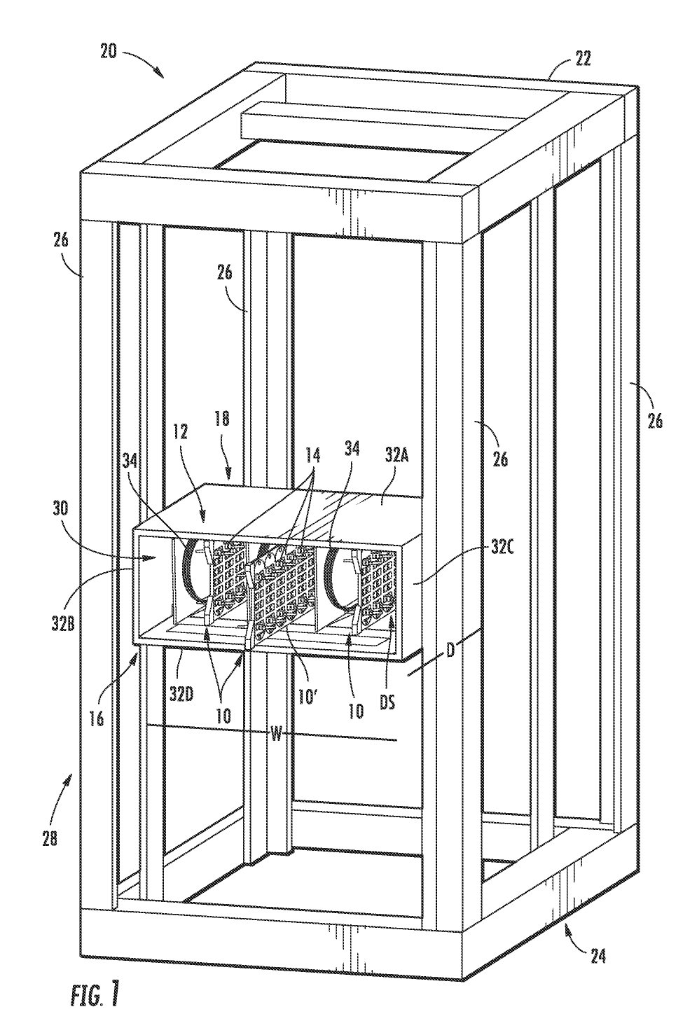

In this regard, FIGS. 1-3B illustrate a first embodiment of fiber optic panels that may be employed in the form of fiber optic patch panels 10. The fiber optic patch panels 10 are configured to be inserted into a chassis 12. The chassis 12 supports and moveably retains the fiber optic patch panels 10. The fiber optic patch panels 10 are configured to receive and retain a plurality of fiber optic components 14 along a depth axis D in a depth space DS formed inside the chassis 12. In this manner, the area of the depth space DS of the chassis 12 is utilized to retain fiber optic components 14 so that a greater number or density of fiber optic components 14, and as a result, a greater number of fiber optic connections, can be supported by fiber optic patch panels 10 for a given width W of the chassis 12. Depth space is defined as the space located between ends of a chassis. In this embodiment, the fiber optic components 14 can be disposed through either a front end 16 or a rear end 18 of the chassis 12. A plurality of the fiber optic components 14 are retained in the depth space DS of the chassis 12 between the front end 16 and the rear end 18. The fiber optic components 14 can include any type of fiber optic component, including but not limited to fiber optic connectors and fiber optic adapters. The fiber optic components 14 can be provided to support any number of fiber optic connections desired.

By example without limitation, the fiber optic components 14 may be disposed in the fiber optic patch panel 10 such that a density of up to or at least two hundred sixteen (216) fiber optic connections can be supported per “U” unit size of the chassis 12 (e.g., 1 U may be equal or approximately equal to seventeen (17) inches in width (i.e., X-axis) by 1.75 inches in height (i.e., Y-axis)). The density is dependent on the number of fiber optic components 14 disposed in the fiber optic patch panel 10 and the number of fiber optic connections supported by each fiber optic component 14. For example, a multi-fiber fiber optic component 14 may support two, four, eight or twelve fiber optic connections. Regardless of the particular size of the chassis 12, a greater density of fiber optic connections is possible due to the fiber optic patch panel 10 supporting fiber optic components 14 in the depth space DS of the chassis 12, and as a result, a greater density of fiber optic connections per unit size of width of the chassis 12.

As illustrated in FIG. 1, a fiber optic equipment rack 20 can be provided. The fiber optic equipment rack 20 is configured to hold or support fiber optic equipment or other equipment, including the chassis 12. In this embodiment, the fiber optic equipment rack 20 is comprised of a top section 22 and a base 24 with vertically oriented posts 26 disposed therebetween. Fiber optic equipment, including the chassis 12 supporting one or more fiber optic patch panels 10, is be disposed inside the fiber optic equipment rack 20 between the posts 26 as a convenient method of supporting fiber optic equipment. In this embodiment, the chassis 12 is disposed between two posts 26 on a front end 28 of the fiber optic equipment rack 20. As will be described in more detail below, the chassis 12 is configured to receive one or more fiber optic patch panels 10 in an opening 30 in the chassis 12 formed by enclosure panels 32A-32D to form an enclosure. The fiber optic patch panels 10 can be inserted in the opening 30 and moved (or translated) within the opening 30 about the chassis 12 to gain access and to store the fiber optic patch panels 10 when access is completed. Fiber optic connections between fiber optic cables 34 can be established with the fiber optic components 14 disposed in the fiber optic patch panels 10. One fiber optic patch panel 10′ is shown in FIG. 1 as being moved out or extended from the chassis 12 to allow access to the fiber optic components 14 disposed in the fiber optic patch panel 10′. When access to the fiber optic components 14 is completed, such as by connecting one or more fiber optic cables 34 into the fiber optic components 14, the fiber optic patch panel 10 can be moved back or retracted into the opening 30 to moveably retain the fiber optic patch panel 10 within the chassis 12.

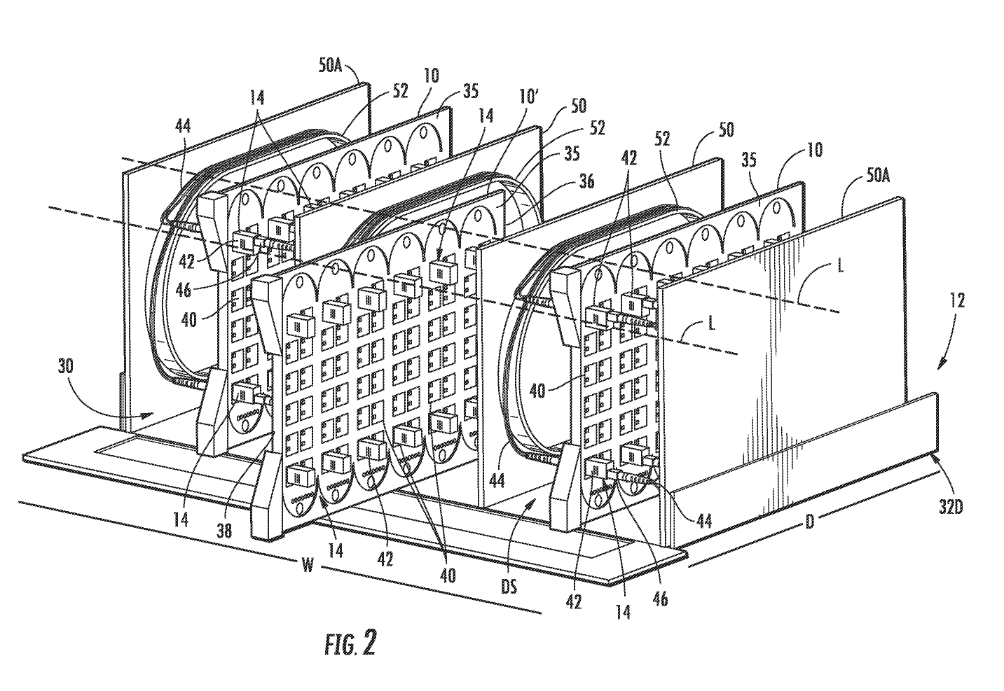

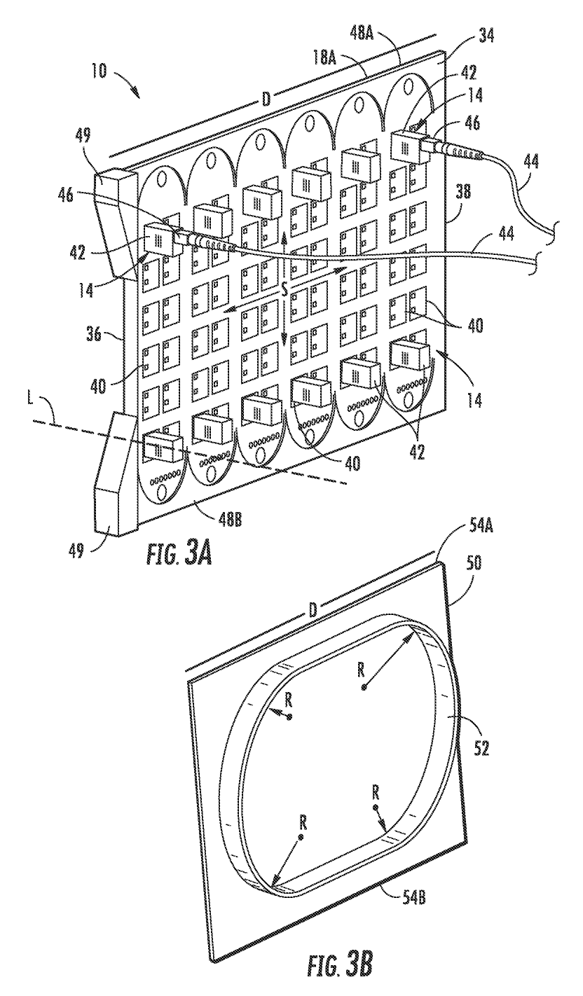

FIGS. 2-3B illustrate more detail regarding the fiber optic patch panels 10 shown as being inserted in the chassis 12 in FIG. 1 and having fiber optic components 14 retained along the depth axis D (i.e., a Z-axis) in a depth space DS formed inside the chassis 12. To illustrate the fiber optic patch panels 10 inserted in the opening 30 of the chassis 12 in more detail, a partial illustration of the chassis 12 is provided in FIG. 2. The top and side enclosure panels 32A-32C of the chassis 12 are not shown to better illustrate the fiber optic patch panels 10 inserted into the opening 30 of the chassis 12. Each fiber optic patch panel 10 in this embodiment is comprised of a planar member 35 comprising a planar surface S disposed between a first end 36 and a second end 38 (see FIG. 3A). A plurality of the fiber optic components 14 are disposed and retained in a plurality of openings 40 in the planar member 35. The fiber optic components 14 are disposed and oriented in the fiber optic patch panel 10 such that the longitudinal axes L of the fiber optic components 14 are not parallel to the depth axis D. In this embodiment, the longitudinal axes L of the fiber optic components 14 are orthogonal to the depth axis D of the chassis 12. Other orientations are possible. The fiber optic components 14 can be disposed and oriented in the fiber optic patch panel 10 such that their longitudinal axes L intersect the depth axis D at angles other than ninety degrees. The openings 40 are also arranged in column and row orientations. However, any other orientation or configuration is possible. Also in this embodiment, the fiber optic components 14 are fiber optic adapters 42 configured to receive fiber optic connectors 46. However, the fiber optic components 14 can be other types of fiber optic components other than adapters. Also, a combination of fiber optic connectors and adapters may be disposed in the openings 40 in the fiber optic patch panel 10 as opposed to just one type of fiber optic component 14.

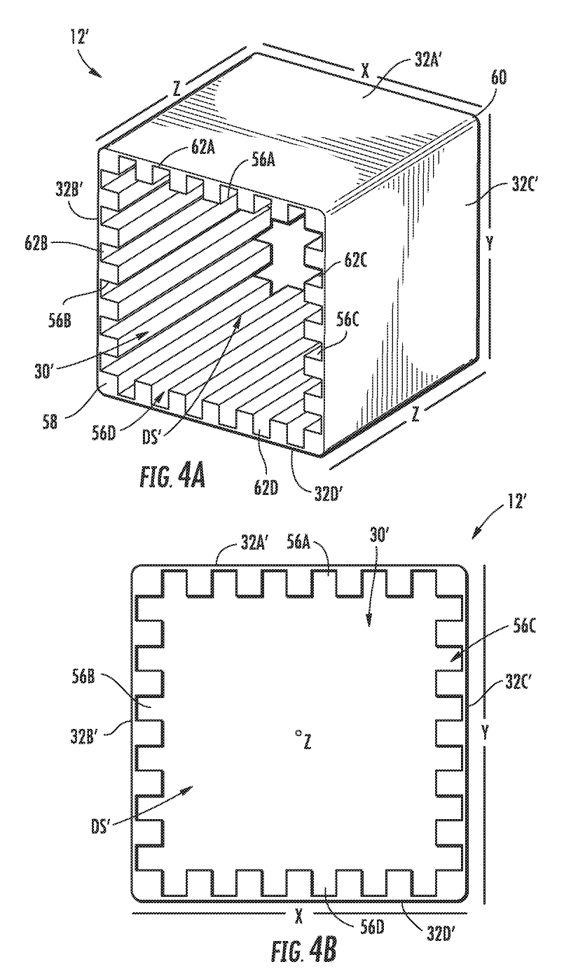

As illustrated in FIGS. 2 and 3A, one or more fiber optic cables 44 each connectorized with fiber optic connectors 46 disposed on its end are connected into the fiber optic adapters 42 to establish fiber optic connections through the fiber optic patch panel 10. As illustrated in FIG. 3A, the fiber optic patch panel 10 in this embodiment includes rails 48A, 48B used to guide the fiber optic patch panel 10 into a chassis 12. In this manner, the fiber optic patch panel 10 is moveable about the chassis 12 to gain access to the fiber optic components 14 for establishing fiber optic connections. The rails 48A, 48B of the fiber optic patch panels 10 can be inserted into one or more channels in the chassis 12 as will described later below with regard to FIGS. 4A-6. When the desired fiber optic connections have been established, the fiber optic patch panel 10 can be moved back into the chassis 12. The fiber optic components 14 are retained along the depth axis D of the chassis 12 in the opening 30 and in the depth space DS of the chassis 12 (FIG. 2) to provide for a higher density of fiber optic components 14 for a given chassis 12 size. Also, as illustrated in FIG. 3A, the fiber optic patch panel 10 may include one or more finger grips or handles 49 to facilitate a user or technician gripping the fiber optic patch panel 10 for movement either in or out of the chassis 12.

Because the fiber optic patch panel 10 is moveable, it may also be desired to provide for the fiber optic cables 44 to contain slack to allow for extending the fiber optic patch panel 10 out from the chassis 12. Otherwise, movement of the fiber optic patch panel 10 out from the chassis 12 may risk disconnecting the fiber optic cable 44 from the fiber optic components 14. In this regard, a slack management device may be employed to store any slack in the fiber optic cable 44 after fiber optic connections have been established with fiber optic components 14. Thus, when the fiber optic patch panel 10 is extended from the chassis 12, the slack in the fiber optic cable 44 allows the fiber optic connection established with the fiber optic cable 44 to be retained without interruption. In this regard, a fiber optic guide panel 50 can be provided as illustrated schematically in FIGS. 2 and 3B to provide for retaining slack storage of a fiber optic cable 44 connected to a fiber optic component 14 in the fiber optic patch panel 10. Any slack cable in the fiber optic cable 44 can be routed around a retention member 52 as illustrated in FIG. 2. More than one fiber optic cable 44 can be routed around the retention member 52. By being included on the fiber optic guide panel 50, the retention member 52 can be disposed in the chassis 12 adjacent a fiber optic patch panel 10 as illustrated in FIG. 2. Thus, fiber optic cables 44 connected to fiber optic components 14 on a fiber optic patch panel 10 can be retained by the retention member 52 located adjacent to the fiber optic patch panel 10 when connected for convenient storage.

The retention members 52 may be disposed on both sides of the fiber optic guide panel 50 so that retention members 52 are located adjacent fiber optic components 14 from two adjacent fiber optic patch panels 10 installed in the chassis 12 as illustrated in FIG. 2. Fiber optic guide panels 50A designed for installation adjacent the enclosure panels 32B, 32C of the chassis 12 may be provided having a retention member 52 only on one side since there will be no fiber optic patch panel 10 located on both sides of the fiber optic guide panels 50A.

In this embodiment, the retention member 52 is provided in a loop configuration, but any other design or geometry is possible. The retention member 52 could include a spool or other type of retracting mechanism to allow for retraction of slack in a fiber optic cable 44 connected to a fiber optic patch panel 10 when the fiber optic patch panel 10 is retracted into the chassis 12. Also like the fiber optic patch panel 10, the fiber optic guide panel 50 can be designed to be moved about the chassis 12 so that the fiber optic cables 44 retained by the retention member 52 can be moved along with the fiber optic patch panel 10 when establishing and/or modifying fiber optic connections if desired. The fiber optic guide panels 50 include rails 54A, 54B (FIG. 3B) that can be inserted into one or more channels disposed in the chassis 12, discussed in more detail below, to retain and allow the fiber optic guide panels 50 to move about the chassis 12.

Further, in order to prevent or assist in the prevention of bending or kinking of the fiber optic cable 44 beyond a minimum desired bend radius, the retention member 52 can also be designed to provide a bend radius R. The retention member 52 can be designed to include one or more bend radii R as illustrated in FIG. 3B. Thus, when the fiber optic cable 44 is routed around the retention member 52, the fiber optic cable 44 is prevented from bending beyond the bend radius R in the retention member 52. The radius of the bend radii R can be designed according to fiber optic cable 44 type and space considerations of the particular chassis 12 and fiber optic patch panel 10.

To further illustrate how the fiber optic patch panels 10 and fiber optic guide panels 50 of FIGS. 2-3B may be disposed and moveable about a chassis 12, FIGS. 4A and 4B illustrate an embodiment of a chassis 12′ that includes channels 56A-56D. The channels 56A-56D are configured to receive the rails 48A, 48B, 54A, 54B of the fiber optic patch panels 10 and fiber optic guide panels 50, respectively. The chassis 12′ is comprised of an enclosure formed by the enclosure panels 32A′-32D′ having an opening 30′ disposed therein along a depth (Z) axis of the chassis 12′ between a first end 58 and a second end 60. One or more channels 56A-56D are disposed in inner surfaces 62A-62D of the enclosure panels 32A′-32D′ extending from the first end 58 to the second end 60 of the chassis 12′ along the depth (Z) axis in the depth space DS′ of the chassis 12′. The chassis 12′ is configured to receive fiber optic patch panels 10 and fiber optic guide panels 50 in the depth (Z) axis inserted into the channels 56A-56D. The fiber optic patch panels 10 and fiber optic guide panels 50 will either be inserted in a width or horizontal dimension in the X-axis direction in channels 56B, 56C, or in a height or vertical dimension in the Y-axis direction in channels 56A, 56D. By the chassis 12′ including channels 56A-56D in both the X-axes and Y-axes, the chassis 12′ provides the flexibility for fiber optic patch panels 10 and fiber optic guide panels 50 to be installed along either the X-axis or Y-axis in the chassis 12′ for flexibility during installation.

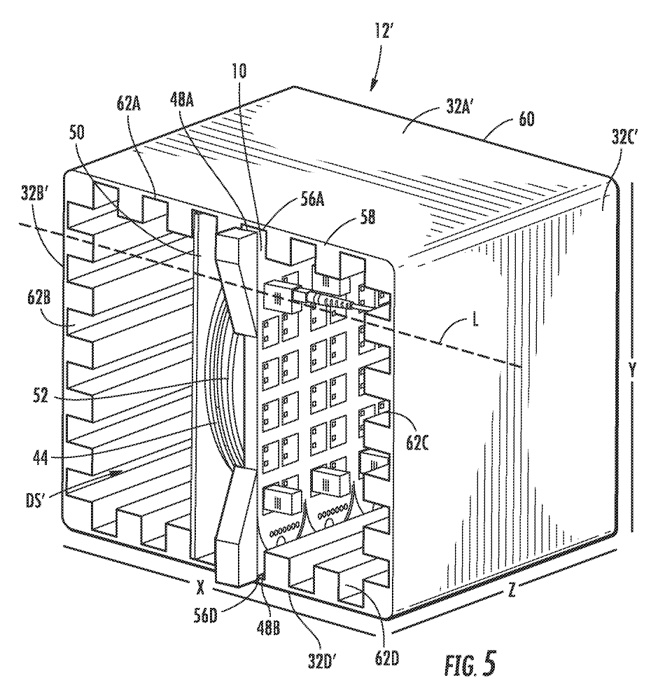

FIG. 5 illustrates how fiber optic patch panels 10 and fiber optic guide panels 50 can be installed in the vertical or Y-axis orientation of the chassis 12′ in FIGS. 4A and 4B. As illustrated therein, the rails 48A, 48B of the fiber optic patch panel 10 are inserted into channels 56A, 56D disposed on the top and bottom enclosure panels 32A′, 32D′ of the chassis 12′. As illustrated, a fiber optic guide panel 50 can be disposed in the channels 56A, 56D adjacent the fiber optic patch panel 10 to retain fiber optic cables 44 connected to the fiber optic patch panel 10 like illustrated in FIG. 2. The fiber optic guide panels 50 can be disposed in the channels 56A, 56D in an alternative fashion with fiber optic patch panels 10 disposed in the channels 56A, 56D. The channels 56D in the chassis 12′ of FIG. 5 are aligned opposite or generally opposite from corresponding channels 56A so that the fiber optic patch panels 10 or fiber optic guide panels 50 can be received and oriented in the chassis 12′ in a ninety (90) degree orientation from the top and bottom enclosure panels 32A′, 32D′. Again, the fiber optic patch panels 10 and fiber optic guide panels 50 can be moved in and out of the chassis 12′ in the depth (Z) axis direction for access and retention. Again, the fiber optic patch panels 10 and chassis 12′ in FIG. 5 allow for fiber optic components 14 to be disposed and retained along the depth axis in the depth space DS′ of the chassis 12′ to increase density for a given chassis 12′ size.

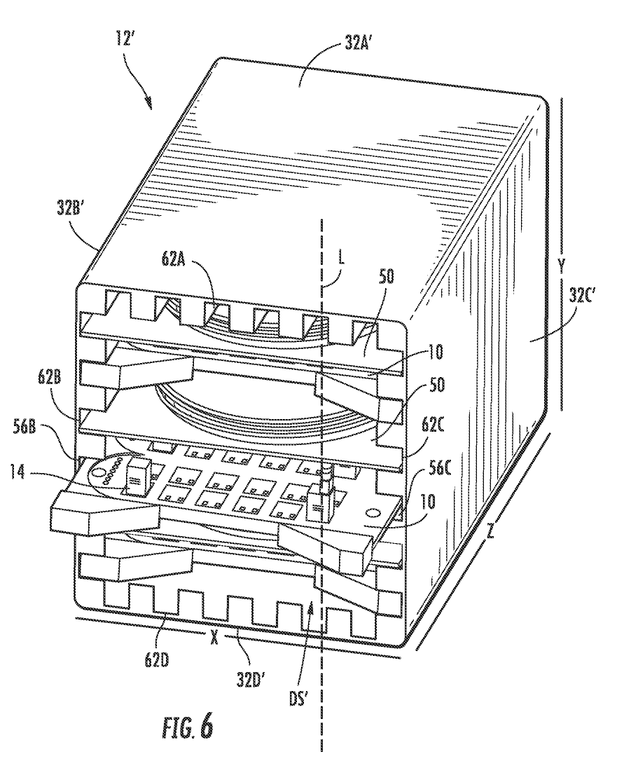

FIG. 6 illustrates how fiber optic patch panels 10 and fiber optic guide panels 50 can be installed in the chassis 12′ in the horizontal or X-axis direction. Just as provided in FIG. 5, the fiber optic patch panels 10 and fiber optic guide panels 50 are inserted into channels 56 in the chassis 12′. However, in this instance, the fiber optic patch panels 10 and fiber optic guide panels 50 are installed between channels 56B, 56C disposed in the side enclosure panels 32B′, 32C′ aligned in the horizontal or X-axis direction. Again, the fiber optic components 14 are disposed and oriented in the fiber optic patch panel 10 such that the longitudinal axes L of the fiber optic components 14 are not parallel to the depth (Z) axis. In this embodiment, the longitudinal axis L is orthogonal to the depth (Z) axis. However, the fiber optic patch panel 10 could be provided that retains fiber optic components such that their longitudinal axes intersect the depth (Z) axis at other angles other than orthogonally. Also, the fiber optic guide panels 50 can be disposed adjacent the fiber optic patch panels 10 to retain fiber optic cables 44 connected to the fiber optic patch panel 10. The fiber optic guide panels 50 can be disposed in the channels 56B, 56C in an alternative fashion with fiber optic patch panels 10 disposed in the channels 56B, 56C. The fiber optic patch panels 10 and fiber optic guide panels 50 can be moved in and out of the chassis 12′ for access and retention. Again, the fiber optic patch panels 10 and chassis 12′ in FIG. 6 allow for fiber optic components 14 to be disposed and retained along the depth axis in the depth space DS′ of the chassis 12′ to increase density for a given chassis 12′ size.

The fiber optic panels that are discussed herein encompass any type of fiber optic equipment and may include fiber optic patch panels and/or fiber optic modules without limitation. The fiber optic panels may support fiber optic adapters, connectors, or any other type of fiber optic component or optical fiber components. Fiber optic components can include adapters or connectors of any connection type, including but not limited to LC, SC, ST, LCAPC, SCAPC, MTRJ, and FC fiber optic connection types. Fiber optic panel housings and panels that are discussed herein encompass any type of fiber optic panel of any size or orientation, including but not limited to bend insensitive optical fibers. A fiber optic cable connected to a fiber optic component disposed in a fiber optic panel includes but is not limited to a cable harness, and may include one or more optical fibers. Further, as used herein, it is intended that terms “fiber optic cables” and/or “optical fibers” include all types of single mode and multi-mode light waveguides, including one or more bare optical fibers, loose-tube optical fibers, tight-buffered optical fibers, ribbonized optical fibers, bend-insensitive optical fibers, or any other expedient of a medium for transmitting light signals.

Many modifications and other embodiments set forth herein will come to mind to one skilled in the art to which the embodiments pertain having the benefit of the teachings presented in the foregoing descriptions and the associated drawings. These modifications include, but are not limited to, the type of panel, chassis, fiber optic component, the configuration of the fiber optic panel or chassis, and/or the number or density of fiber optic components and connections provided in the fiber optic panel, type of routing, whether universal or classic, etc.

Therefore, it is to be understood that the description and claims are not to be limited to the specific embodiments disclosed and that modifications and other embodiments are intended to be included within the scope of the appended claims. It is intended that the embodiments cover the modifications and variations of the embodiments provided they come within the scope of the appended claims and their equivalents. Although specific terms are employed herein, they are used in a generic and descriptive sense only and not for purposes of limitation.

What is claimed is:

1. A fiber optic panel apparatus, comprising:
a chassis having a first end and a second end aligned along a depth axis of the chassis and a depth space therebetween; and
a fiber optic panel configured to be inserted into the chassis between the first end and the second end along the depth axis and configured to retain a plurality of fiber optic components in the depth space between the first end and the second end;
wherein longitudinal axes of the plurality of fiber optic components are not parallel to the depth axis.

2. The fiber optic panel apparatus of claim 1, wherein the fiber optic panel is moveable about the chassis about the depth axis.

3. The fiber optic panel apparatus of claim 1, further comprising a plurality of fiber optic components disposed in the fiber optic panel.

4. The fiber optic panel apparatus of claim 3, wherein the plurality of fiber optic components are each disposed through openings in the fiber optic panel.

5. The fiber optic panel apparatus of claim 3, wherein the fiber optic panel retains the plurality of fiber optic components between the first end and the second end.

6. The fiber optic panel apparatus of claim 3, wherein the plurality of fiber optic components includes fiber optic adapters, fiber optic connectors, or a combination of both fiber optic adapters and fiber optic connectors.

7. The fiber optic panel apparatus of claim 1, further comprising a channel disposed along the depth axis between the first end and the second end of the chassis;
wherein the fiber optic panel further comprises a rail inserted into the channel to insert the fiber optic panel into the chassis between the first end and the second end.

8. The fiber optic panel apparatus of claim 7, wherein the channel is comprised of a plurality of channels oriented in either a width dimension of the chassis or a height dimension of the chassis.

9. The fiber optic panel apparatus of claim 8, wherein the plurality of channels are oriented orthogonally to the depth axis.

10. The fiber optic panel apparatus of claim 1, further comprising a fiber optic guide panel disposed in the chassis adjacent the fiber optic panel.

11. The fiber optic panel apparatus of claim 10, wherein the fiber optic guide panel is moveable about the chassis.

12. The fiber optic panel apparatus of claim 10, wherein the fiber optic guide panel is inserted in a second channel in the chassis located adjacent to the fiber optic panel.

13. The fiber optic panel apparatus of claim 10, further comprising a plurality of fiber optic components disposed in the fiber optic panel wherein one or more fiber optic cables connected to one or more of the plurality of fiber optic components are routed on the fiber optic guide panel.

14. The fiber optic panel apparatus of claim 13, further comprising a retention member disposed on the fiber optic guide panel, wherein the one or more fiber optic cables are routed on the retention member.

15. The fiber optic panel apparatus of claim 14, further comprising a second retention member disposed on an opposite side of the fiber optic guide panel from the retention member.

16. The fiber optic panel apparatus of claim 1, wherein the fiber optic panel is configured to retain the plurality of fiber optic components sufficient to provide at least two hundred sixteen (216) fiber optic connections per “U” unit size of the chassis.

17. A fiber optic panel, comprising:
a planar member disposed in a plane between a first end and a second end and aligned along a depth axis; and
a plurality of fiber optic components retained in a plurality of openings in the planar member wherein longitudinal axes of the plurality of fiber optic components are not parallel to the depth axis;
wherein the planar member is configured to move along the depth axis of the planar member within a chassis having a depth space.

18. The fiber optic panel of claim 17, wherein the plurality of openings are arranged in a column and row orientation.

19. The fiber optic panel of claim 17, wherein the plurality of fiber optic components includes fiber optic adapters, fiber optic connectors, or a combination of both fiber optic adapters and fiber optic connectors.

20. The fiber optic panel of claim 17, further comprising a handle disposed on the first end of the fiber optic panel.

21. The fiber optic panel of claim 17, further comprising a rail disposed between the first end and the second end of the fiber optic panel.

22. The fiber optic panel of claim 21, wherein the rail is inserted into a channel in the chassis and moveable within the channel about the chassis.

23. The fiber optic panel of claim 17, wherein the planar member is configured to retain the plurality of fiber optic components sufficient to provide at least two hundred sixteen (216) fiber optic connections per “U” unit size of the chassis.

24. A fiber optic panel chassis, comprising:
an enclosure having an opening disposed therein along a depth axis of the chassis between a first end and a second end of the enclosure and a depth space therebetween;
at least one first channel disposed in an inner surface of a first side of the enclosure along the depth axis; and
at least one second channel disposed in an inner surface of a second side of the enclosure along the depth axis opposite the first side;
wherein the enclosure is configured to receive a fiber optic panel in the depth space inserted in the at least one first channel and the at least one second channel.

25. The fiber optic panel chassis of claim 24, wherein the at least one first channel is comprised of a plurality of first channels and the at least one second channel is comprised of a plurality of second channels each aligned opposite from a channel among the plurality of first channels.

26. The fiber optic panel chassis of claim 24, further comprising:
at least one third channel disposed in an inner surface of a third side of the enclosure along the depth axis and oriented orthogonally or substantially orthogonally to the first side and the second side; and
at least one fourth channel disposed in an inner surface of a fourth side of the enclosure along the depth axis opposite the third side;
wherein the enclosure is configured to receive the fiber optic panel in the depth space inserted in the at least one third channel and the at least one fourth channel.

27. The fiber optic panel chassis of claim 26, wherein the at least one third channel is comprised of a plurality of third channels and the at least one fourth channel is comprised of a plurality of fourth channels each aligned opposite from a channel among the plurality of third channels.

28. A fiber optic panel chassis, comprising:
an enclosure having an opening disposed therein along a depth axis of the chassis between a first end and a second end of the enclosure and a depth space therebetween;
a first channel disposed in the enclosure having a longitudinal axis along the depth axis and a vertical latitudinal axis; and
a second channel disposed in the enclosure having a longitudinal axis along the depth axis and a horizontal latitudinal axis;
wherein the enclosure is configured to receive a fiber optic panel in the depth space inserted in the first channel in a vertical orientation or in the second channel in a horizontal orientation.
